(19) United States
(12) Patent Application Publication
(10) Pub. No.: US 2021/0033029 A1
(43) Pub. Date: Feb. 4, 2021

(54) TURBOMACHINERY WITH CENTRED CASINGS

(71) Applicant: Bowman Power Group Limited, Southampton (GB)

(72) Inventors: Robert Jonathan James Fallon, Southampton (GB); Keith Fry, Southampton (GB); James Smith, Southampton (GB); Shinri Szymko, Southampton (GB)

(21) Appl. No.: 16/964,145

(22) PCT Filed: Jan. 30, 2019
(86) PCT No.: PCT/GB2019/050261

§ 371 Date: Jul. 22, 2020

(30) Foreign Application Priority Data
Jan. 31, 2018 (GB) 1801594.1

(51) Int. Cl. F02C 7/32; F02C 7/20; F01D 25/24; F01D 25/28

(52) U.S. Cl. CPC F02C 7/32; F02C 7/20; F05D 2230/642; F01D 25/28; F01D 25/24

(57) ABSTRACT

Turbomachinery comprising a turbine housing (200) with an engagement formation (210) and a casing (400) for electrical machinery, the casing (400) including an engagement recess (410). Furthermore, the engagement recess (410) comprises a cantilever member (420) and is adapted to receive the engagement formation (210). Finally, the engagement recess (410) and engagement portion (210) are configured such that during operation of said turbomachinery the engagement formation undergoes thermal expansion to expand relative to the engagement recess and exert pressure on the cantilever (member 420). In this way, an improved apparatus for centralising the turbine housing (200) in relation to the casing (400) is provided.

### FIELD OF THE INVENTION

The present invention relates to turbomachinery, and more particularly to turbomachinery comprising a turbine housing and a casing for electrical machinery.

### BACKGROUND TO THE INVENTION

Turbomachinery, in mechanical engineering, describes machines that transfer energy between a rotor and a fluid, including both turbines and compressors. While a turbine transfers energy from a fluid to a rotor, a compressor transfers energy from a rotor to a fluid.

Turbomachinery is frequently used in industrial settings. One such application is the use of a turbogenerator to extract energy from the exhaust flow of an engine. In this application, the electrical components of the turbogenerator may be cooled by fluids to ensure their temperature remains within a specified operating range, frequently below 65° C. Simultaneously, the turbogenerator turbines and turbine housing may experience much higher temperatures, frequently in excess of 600° C.

Turbogenerators are most usually installed at an ambient temperature. As such, the large temperature differences between components of the turbogenerator during operation give rise to both high stresses and significant movement between adjacent parts. These issues arise due to differences in thermal expansion. Additionally, large temperature differences may also result in significant temperature gradients across the turbogenerator.

One area where these differences in thermal expansion may prove especially critical is in the clearance between the turbine and its housing or shroud. This clearance is of significant importance as it has a direct effect on both the efficiency and reliability of the turbogenerator as a whole. Recently, this problem has become still more pertinent, as modern high speed turbogenerators regularly incorporate turbines spinning in excess of 30,000 rpm, resulting in a compact, power dense system. For the clearance between a turbine and its housing to be optimal, it is important that the turbine is correctly centred within the housing.

Various methods of ensuring the turbine remains centred within the housing have been developed. In one method, flanges may be located on the exterior of both the turbine housing and the electrical machinery which comprises the turbine. In use, the turbine is inserted into the turbine housing such that it is centred, and the respective flanges of the housing and the electrical equipment abut. The respective flanges are then held in place via a circular clamp or v-band being tightened around them. Whilst such a system is useful in ensuring the turbine is centred within the housing, this method has disadvantages in that the clamp or v-band is a single point of failure, necessitating very high-quality components at significant expense. Additionally, each clamp or v-band has a limited lifespan due to the stress experienced during the tightening process.

Alternatively, flanges located on the exterior of both the turbine housing and the electrical machinery which comprises the turbine may be simply bolted together. In this way, multiple bolts are used, so the issue of a single point of failure is absent. However, to ensure precise radial alignment in such a system, it is necessary to include interlocking formations on the flanges. Such interlocking formations increase the contact area between the turbine housing and the electrical machinery, resulting in a high rate of heat transfer and difficulty in cooling the electrical machinery to the required operational level.

Aspects of the present invention seek to address at least the above problems.

### SUMMARY OF THE INVENTION

According to a first aspect of the present invention, there is provided turbomachinery comprising a turbine housing comprising an engagement formation, and a casing for electrical machinery comprising an engagement recess, wherein the engagement recess comprises a cantilever member, the engagement recess adapted to receive the engagement formation, and wherein the engagement formation and the engagement recess are configured such that during operation of said turbomachinery the engagement formation undergoes thermal expansion to expand relative to the engagement recess and exert pressure on the cantilever member.

In this way, apparatus for the efficient radial alignment of the turbine housing relative to the casing throughout the warm-up and cool down phases of operation, as well as in the steady state phase is provided. This improved centralisation is provided due to the spring force exerted by the cantilever member on the engagement formation during operation of the turbomachinery. Additionally, the radial alignment of the turbine housing at low operating temperatures, temperatures between 50 and 100° C., be may be provided. Furthermore, the looser fit of the engagement formation into the engagement recess ensures the turbomachinery may be more easily assembled by a user at ambient temperature before operation.

Preferably, the turbomachinery further comprises a turbine located within the turbine housing and extending from the casing.

Preferably there is a gap or space between the engagement formation and the length of the cantilever member at ambient temperature. Here ambient temperature is taken to be the room temperature of a factory or workplace environment, typically between 10 and 40° C. inclusive. More preferably, there is a gap or space between the engagement formation and the length of the cantilever member between the temperatures of 50 and 100° C. Such a feature is advantageous as it allows the engagement formation to be inserted into the engagement recess more easily during assembly of the turbomachinery.

Preferably, the cantilever member comprises an annular cross section. Preferably, the cantilever member is curved around an axis parallel to is length. Preferably, a side of the engagement recess comprises or is formed by the cantilever member.

Preferably, the thermal expansion coefficient of the turbine housing differs from the thermal expansion coefficient of the casing. Optionally, the thermal expansion coefficient of the turbine housing is greater than the thermal expansion coefficient of the casing. More preferably, the thermal expansion coefficient of the turbine housing is within 30%, more preferably 25%, still more preferably 15% and most preferably 10% of the thermal expansion coefficient of the casing. Most preferably, the thermal expansion coefficient of the turbine housing is the same as the thermal expansion coefficient of the casing. By utilising materials with similar or the same thermal expansivities for the turbine housing and the casing, the centring effect may be extended to a wider range of temperatures as the stress in the cantilever will be limited to an acceptable level.

Preferably, the engagement formation comprises a taper or chamfer. More preferably, the taper or chamfer extends around the entire perimeter of the engagement formation. Such a feature may be advantageous as it may ease the insertion of the engagement formation into the engagement recess upon assembly.

Preferably, the length of the cantilever member is extended by an undercut within the engagement recess. Such a feature may be advantageous as it serves to increase the length of the cantilever member and, therefore, the spring force it may exert on the engagement formation.

Preferably the undercut comprises a rounded profile. Preferably the undercut comprises a curved profile. Such a feature may be preferred as a rounded or curved profile for the cutaway or undercut may prevent issues of cracking and breaking rising due to stress concentrations.

Preferably a surface of the engagement formation comprises a textured area. More preferably an entire surface of the engagement formation is textured. Alternatively, the surface of the engagement formation may be smooth to ensure accurate control of its diameter. Preferably a surface of the engagement recess comprises a textured area. More preferably an entire surface of the engagement recess is textured. The provision of a textured surface may be preferable as it may reduce the contact area, and thus heat transfer between the turbine housing and the casing.

Preferably the turbomachinery further comprises a gasket between the turbine housing and the casing. More preferably, the thermal conductivity of the gasket is lower than the thermal conductivity of both the turbine housing and the casing. Such a feature may be advantageous as the use of a gasket, or a gasket with low thermal conductivity, may assist in preventing heat transfer from the turbine housing to the casing.

Preferably, the cantilever member comprises a groove, ridge or channel positioned facing a surface of the engagement formation. More preferably, a plurality of groves, channels of ridges may be provided. Such a feature may be preferred to reduce the contact area between the turbine housing and the casing, therefore reducing heat transfer.

Preferably the turbomachinery further comprises a stud connecting the turbine housing to the casing. Preferably the stud comprises a plurality of segments. The use of a stud may be preferable to assist in the axial alignment of the turbine housing relative to the casing. The use of a segmented stud may be preferred to reduce heat transfer.

Preferably the stud extends through the casing to engage with the turbine housing. Preferably, the aperture in the casing through which the stud extends has a diameter greater than that of the stud. Preferably, the aperture in the casing through which the stud extends has a diameter 115% to 101% of that of the stud, more preferably 110% to 105% of that of the stud and most preferably 108% of that of the stud.

Preferably the stud comprises a screw thread. The use of a threaded stud may assist in preventing heat transfer by virtue of multiple portions of thread within the heat flow path.

Preferably the turbine housing comprises a plurality of engagement formations, and the casing comprises a plurality of engagement recesses. Preferably the plurality of engagement formations, and the casing comprises a plurality of engagement recesses are spaced equally around the perimeter of the turbine housing and casing. Alternatively, a single engagement formation and engagement recess may extend around the entire perimeter of the turbine housing and casing respectively.

Preferably, the turbomachinery is a turbogenerator.

According to a second aspect of the present invention there is provided a turbine housing for use in turbomachinery with the features described above.

According to a third aspect of the present invention, there is provided a casing for electrical machinery for use in the turbomachinery with the features described above.

### DETAILED DESCRIPTION

Embodiments of the present invention will now be described by way of example only and with reference to the accompanying drawings, in which:

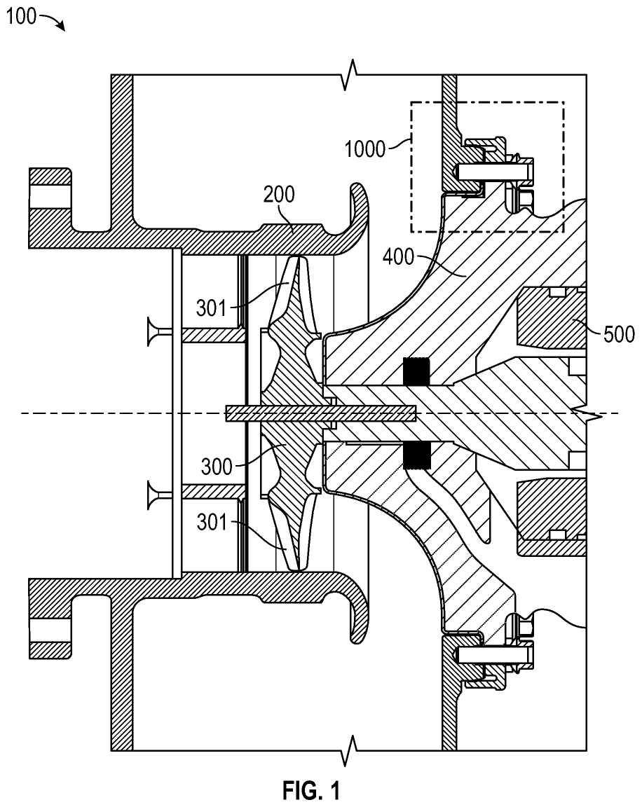

FIG. 1 is a schematic cross-sectional view of turbomachinery in accordance with the present invention; and

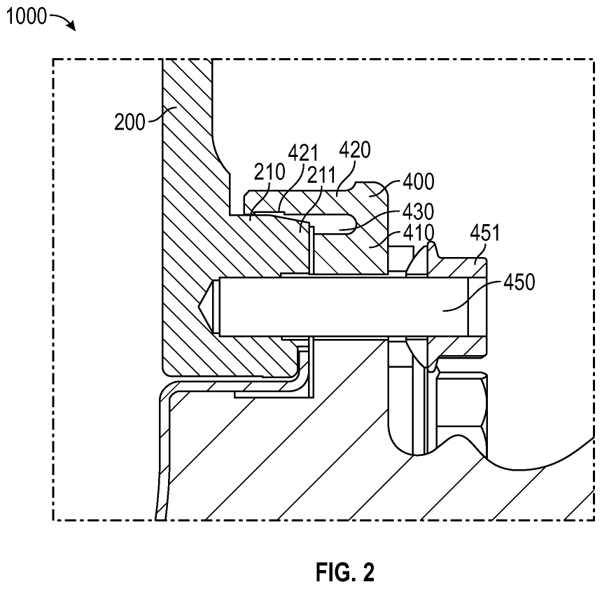

FIG. 2 is an expanded, schematic cross-sectional view of the area highlighted in FIG. 1.

Referring to FIG. 1 of the drawings, there is shown a piece of turbomachinery 100 in accordance with the present invention. Here, the piece of turbomachinery comprises a turbine housing 200, a turbine 300, and a casing 400. The casing 400 contains a portion of the turbine 300 and further electrical components 500 required for operation of the turbomachinery. As is typical for turbomachinery, the tips of the turbine blades 301 are located in close proximity to an interior surface of the turbine housing 200 to ensure efficient operation.

To ensure the tips of the turbine blades 301 are held in close proximity to the turbine housing 200, the turbine housing 200 is affixed to the casing 400 by multiple fastening arrangements 1000. These fastening arrangements 1000 are positioned around the periphery of the turbine housing 200 and the casing 400, where the turbine housing 200 and the casing 400 abut. The fastening arrangements 1000 may be spaced equally around the periphery or perimeter of the turbine housing 200 and the casing 400. Alternatively, a single fastening arrangement 1000 may extend around the entire perimeter of the turbine housing 200 and the casing 400.

The fastening arrangement 1000 is depicted in greater detail in FIG. 2. Again, the turbine housing 200 and the casing 400 are illustrated, alongside further features of this embodiment of the invention.

An engagement formation, protrusion or spigot 210 is located on the outside of the turbine housing 200. The engagement formation 210 extends from an outer surface of the turbine housing 200. This engagement formation 210 has a generally rectangular cross section. Additionally, the engagement formation 210 comprises a tapered or chamfered portion 211 located at its distal end.

The casing 400 includes and engagement recess, hole or blind aperture 410. This engagement recess 410 is formed on two side by the casing 400, and is formed on a third side by a cantilever member or locating projection 420. The cantilever member 420 extends from a surface of the the housing 400 to form a third side of the engagement recess 410. The cantilever member 430 is curved around an axis parallel to its length. Additionally, the cantilever member 430 may have an annular cross section.

The engagement recess 410 is sized to house, fit or accommodate the engagement formation 210. The engagement formation 210 fits relatively loosely within the engagement recess 410, such that insertion of the engagement formation 210 into the engagement recess 410 may be easily undertaken by the user during assembly of the turbomachinery 100.

The length of the cantilever member 420 is extended by a cutaway or undercut 430 located within the engagement recess 410. The undercut 430 extends in a direction generally parallel to the direction of the cantilever member 420. The undercut 430 has a curved, rounded or circular cross section, such that the issues of stress concentration are mitigated.

The cantilever member 420 includes a groove or channel 421. This groove 421 is located on a lower surface of the cantilever member 420, adjacent to the engagement formation 210. Additionally, areas of the surface of any or all of the cantilever member 420, groove 421, engagement recess 410 or engagement formation 210 may have a textured or roughened surface texture.

A barrier material or gasket 440 is located between the engagement formation 210 and the casing 400 in the engagement recess 410. The gasket 440 is formed of a material with a low thermal conductivity such as a chemically and thermally exfoliated vermiculite and/or steatite material. In this embodiment, the gasket 440 is formed of a material with a lower thermal conductivity than both the turbine housing 200 and the casing 400.

The fastening arrangement includes a stud, fastener, or bar 450 which extends through the casing 400 into the turbine housing 200. This stud 450 assists the location of the turbine housing 200 in relation to the casing 400, providing an axial clamping force. The stud includes a screw thread, on to which a nut 451 is tightened by a user during the assembly of the turbomachinery 100. To ensure the nut 451 does not excessively restrict the radial movement of the turbine housing 200 in relation to the casing 400, a spherical washer is used between the nut 451 and the casing 400. To further ensure the turbine housing 200 is free to move radially relative to the casing 400, the casing aperture through which the stud 450 is inserted is slightly larger than the stud itself. In this embodiment, the aperture has a diameter 108% that of the stud 450.

Due to the different temperatures experienced by the turbine housing 200 and the and the casing 400 during operation of the turbomachinery 100, the engagement formation 210 effectively expands within the engagement recess 410. Initially, due to the relatively loose fit of the engagement formation 210 within the engagement recess 410, the engagement formation 210 is not in contact with the cantilever member 420. However, as the engagement formation 210 thermally expands, it comes into contact with the cantilever member 420. The cantilever member 420 then exerts a spring force on to the engagement formation 210, assisting in the centralisation of the turbine housing 200 relative to the casing 400. The force of the cantilever member 420 on the engagement formation 210 is increased by the undercut 430, which effectively increases the length of the cantilever member 420. Such a system ensures that the turbine housing 200 is centralised relative to the casing 400 throughout the warm-up and cool down phases of operation, as well as in the steady state phase.

1. Turbomachinery comprising,
a turbine housing comprising an engagement formation, and
a casing for electrical machinery comprising an engagement recess,
wherein said engagement recess comprises a cantilever member,
said engagement recess adapted to receive said engagement formation, and
wherein said engagement formation and said engagement recess are configured such that during operation of said turbomachinery said engagement formation undergoes thermal expansion to expand relative to said engagement recess and exert pressure on said cantilever member.

2. The turbomachinery of claim 1, wherein said turbomachinery apparatus further comprises a turbine located within said turbine housing and extending from said casing.

3. The turbomachinery of claim 1, wherein there is a gap or space between the engagement formation and the length of the cantilever member at ambient temperature.

4. The turbomachinery of claim 1, wherein said cantilever member comprises an annular cross section.

5. The turbomachinery of claim 1, wherein a side of said engagement recess comprises said cantilever member.

6. The turbomachinery of claim 1, wherein the thermal expansion coefficient of said turbine housing differs from the thermal expansion coefficient of said casing.

7. The turbomachinery of claim 6, wherein the thermal expansion coefficient of said turbine housing is within 30% of the thermal expansion coefficient of said casing.

8. The turbomachinery of claim 1, wherein the engagement formation comprises a taper or chamfer.

9. The turbomachinery of claim 1, where the length of the cantilever member is extended by a undercut within the engagement recess.

10. The turbomachinery of claim 9, wherein the undercut comprises a rounded profile.

11. The turbomachinery of claim 1, wherein a surface of said engagement formation comprises a textured area.

12. The turbomachinery of claim 11, wherein an entire surface of the engagement formation is textured.

13. The turbomachinery of claim 1, wherein a surface of said engagement recess comprises a textured area.

14. The turbomachinery of claim 13, wherein an entire surface of the engagement recess is textured.

15. The turbomachinery of claim 1, wherein the turbomachinery further comprises a gasket between said turbine housing and said casing.

16. The turbomachinery of claim 15, wherein the thermal conductivity of said gasket is lower than the thermal conductivity of both said turbine housing and said casing.

17. The turbomachinery of claim 1, wherein said cantilever member comprises a groove positioned facing a surface of said engagement formation.

18. The turbomachinery of claim 1, wherein said turbomachinery further comprises a stud connecting said turbine housing to said casing.

19. The turbomachinery of claim 18, wherein said stud extends through said casing to engage with said turbine housing.

20. The turbomachinery of claim 18, wherein said stud comprises a screw thread.

21. The turbomachinery of claim 1, wherein said turbine housing comprises a plurality of engagement formations, and said casing comprises a plurality of engagement recesses.

22. The turbomachinery of claim 1, wherein said turbomachinery is a turbogenerator.

23. A turbine housing for use in the turbomachinery of claim 1.

24. A casing for electrical machinery for use in the turbomachinery of claim 1.
